(19) United States
(12) Patent Application Publication
(10) Pub. No.: US 2017/0075648 A1
(43) Pub. Date: Mar. 16, 2017

(54) HOME APPLIANCE CONTROL SYSTEM AND CONTROL METHOD THEREOF

(71) Applicant: Nuvoton Technology Corporation, Hsinchu (TW)

(72) Inventors: Chi-Yung SUN, Hsinchu City (TW); Wen-Tang CHANG, Hsinchu City (TW)

(21) Appl. No.: 15/219,552

(22) Filed: Jul. 26, 2016

(30) Foreign Application Priority Data
Sep. 16, 2015 (TW) 104130549

(51) Int. Cl. G06F 3/16; H04L 12/28

(52) U.S. Cl. CPC G06F 3/165; H04L 12/2816

(57) ABSTRACT

A home appliance control system is provided. The home appliance control system includes a portable device and a home appliance device. The portable device includes a first microphone, a first speaker, and a first processor. The first processor provides a first packet formed by a plurality of first audio signals through the first speaker according to an instruction. The home appliance device includes a second microphone, a second speaker, and a second processor. The second microphone receives the first packet from the first speaker of the portable device. The second processor obtains the instruction according to the first audio signals of the first packet received by the second microphone, and controls the home appliance device to perform an operational program according to the instruction.

### CROSS REFERENCE TO RELATED APPLICATIONS

This Application claims priority of Taiwan Patent Application No. 104130549, filed on Sep. 16, 2015, the entirety of which is incorporated by reference herein.

### BACKGROUND OF THE INVENTION

Field of the Invention

The present disclosure relates to a home appliance control system, and more particularly to a control system for a home appliance device.

Description of the Related Art

With technological advances constantly being made, smart home appliances have gradually been adopted by many families. Currently, a user can control the operation of smart home appliances via wireless communication (e.g. Bluetooth, WiFi technology, etc.) through an electronic device (e.g. a mobile phone, a tablet PC, etc.). However, for smart home appliances, radio frequency (RF) modules and baseband circuits used in a wireless communication technology incur higher manufacturing costs. Therefore, a control method with a low cost is desired for a home appliance device.

### BRIEF SUMMARY OF THE INVENTION

A home appliance control system and a control method thereof are provided. An embodiment of a home appliance control system is provided. The home appliance control system comprises a portable device and a home appliance device. The portable device comprises a first microphone, a first speaker, and a first processor. The first processor provides a first packet formed by a plurality of first audio signals through the first speaker according to an instruction. The home appliance device comprises a second microphone, a second speaker, and a second processor. The second microphone receives the first packet from the first speaker of the portable device. The second processor obtains the instruction according to the first audio signals of the first packet received by the second microphone, and controls the home appliance device to perform an operational program according to the instruction.

Furthermore, an embodiment of control method for a home appliance control system is provided, wherein the home appliance control system comprises a portable device and a home appliance device. A first packet is received, formed by a plurality of first audio signals from the portable device through a microphone of the home appliance device. An instruction is obtained from the portable device according to the first audio signals of the first packet. The home appliance device is controlled to perform an operational program according to the instruction. The instruction comprises the operating mode and the operating time of the home appliance device.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIG. 1 shows a home appliance control system according to an embodiment of the present disclosure;

FIG. 2 shows a home appliance control system according to another embodiment of the present disclosure; and

FIG. 3 shows a control method for a home appliance control system according to an embodiment of the present disclosure.

### DETAILED DESCRIPTION OF THE INVENTION

The following description is of the best-contemplated mode of carrying out the present disclosure. This description is made for the purpose of illustrating the general principles of the present disclosure and should not be taken in a limiting sense. The scope of the present disclosure is best determined by reference to the appended claims.

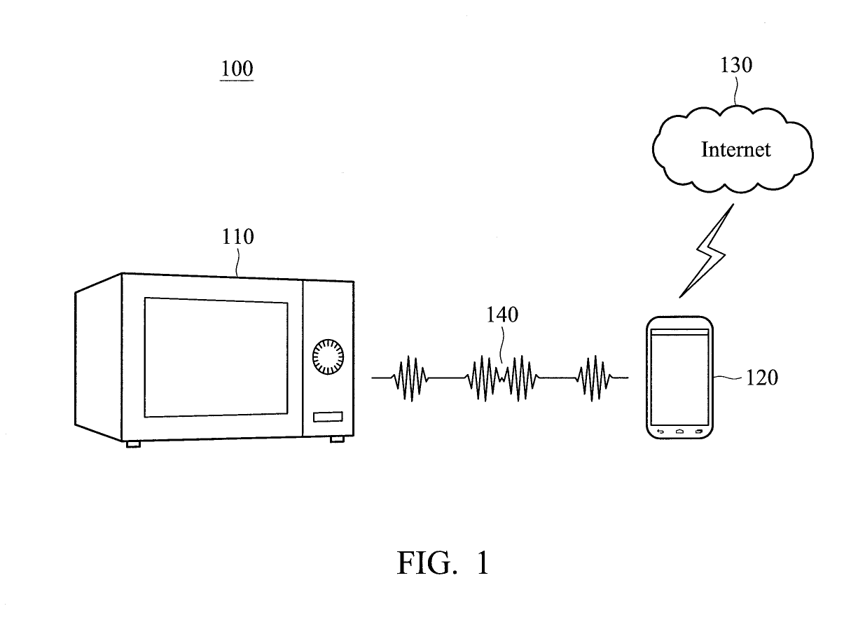

FIG. 1 shows a home appliance control system 100 according to an embodiment of the present disclosure. The home appliance control system 100 comprises a home appliance device 110 and a portable device 120. In the embodiment, the portable device 120 is a smart phone, and the home appliance device 110 is an oven. In other embodiments, the portable device 120 may be a tablet PC, and the home appliance device 110 may be a microwave oven, a lamp, a washing machine, and so on. In the home appliance control system 100, the portable device 120 can communicate with the home appliance device 110 through an audio signal (label 140). For example, the portable device 120 can download various recipes from the Internet 130, wherein each recipe comprises the operation setting regarding the cooking temperature and the cooking time in the oven 110, i.e. the operating mode and the operating time of the home appliance device. Next, the user can select the desired oven-operation-setting through the portable device 120, and transmit the selected oven-operation-setting (e.g. temperature, time, etc.) to the oven 110 through a plurality of audio signals, so that the oven 110 can begin to operate according to the oven-operation-setting. Thus, by using the portable device 120 to transmit the audio signals for setting the oven 110, it is more rapid and convenient for the user to operate the oven 110. It should be noted that the audio signal is a single tone or a multi-tone. Furthermore, the audio signal may be an audible sound or ultrasound.

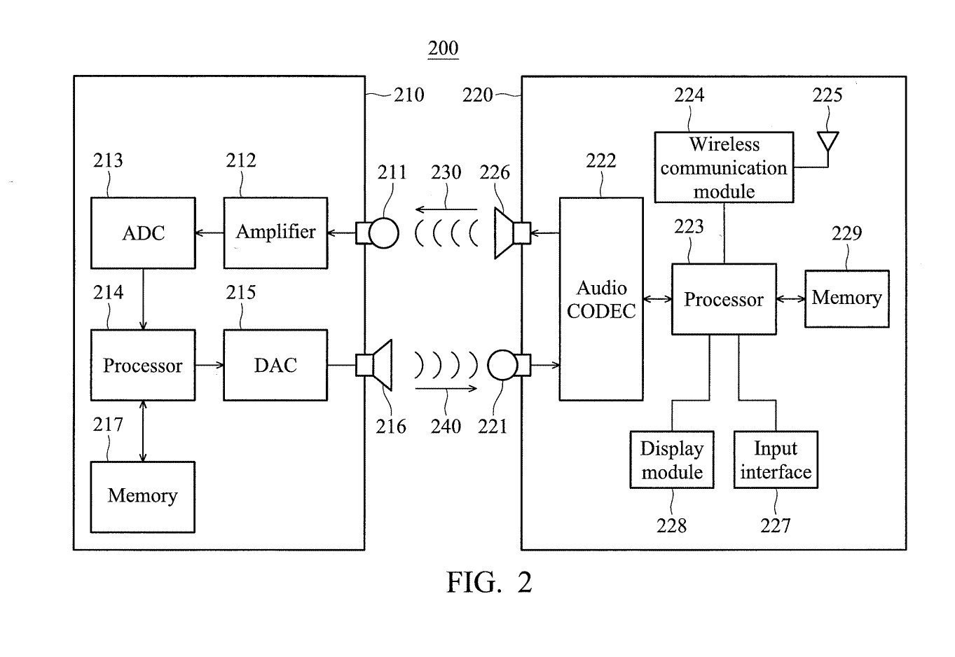

FIG. 2 shows a home appliance control system 200 according to another embodiment of the present disclosure. The home appliance control system 200 comprises a home appliance device 210 and a portable device 220. The portable device 220 comprises a microphone 221, an audio CODEC 222, a processor 223, a wireless communication module 224, an antenna 225, a speaker 226, an input interface 227, a display module 228, and a memory 229. The processor 223 connects to the Internet (not shown) through the wireless communication module 224 and the antenna 225, downloads various operation settings from the Internet that can be performed by the home appliance device 210, and stores the operation settings into the memory 229. In the portable device 220, when running a smart appliance program, the processor 223 can display the various operation settings of the home appliance device 210 through the display module 228, for the user to view and select. As described above, the operation setting of the home appliance device 210 comprises the operating mode and the operating time of the home appliance device 210. When the user selects the desired operation setting through the input interface 227, the processor 223 can, obtain the selected operation setting from the memory 229 according to user's input via the input interface 227. Next, the processor 223 controls the audio CODEC 222 to convert the selected operation setting into a first packet comprising a plurality of audio signals, and to transmit the first packet to the home appliance device 210 through the speaker 226, shown as arrow 230. In one embodiment, the audio signals of the first packet are divided into a preamble section, a data section, and an end section. Moreover, the audio signals corresponding to the preamble section represent the header signals and/or synchronization signals. The audio signals corresponding to the data section represent the selected operation setting. The audio signals corresponding to the end section represent the identification code of the first packet. In FIG. 2, the input interface 227 may be a touch panel or a keyboard.

In FIG. 2, the home appliance device 210 comprises a microphone 211, an amplifier 212, an analog-to-digital converter (ADC) 213, a processor 214, a digital-to-analog converter (DAC) 215, a speaker 216 and a memory 217. After the user selects the desired operation setting through the portable device 220, the microphone 211 of the home appliance device 210 receives the first packet from the portable device 220. Next, the amplifier 212 amplifies and filters the audio signals of the first packet. Next, the ADC 213 converts each amplified audio signal into a digital signal. Next, according to the digital signals from the ADC 213, the processor 214 can obtain the operation setting selected by the user. In response to the operation setting selected by the user, the processor 214 can control the home appliance device 210 to perform the corresponding operational program. For example, if the home appliance device 210 is a lamp, the user can select a sleep mode (wherein only one light bulb is turned on), a read mode (wherein all light bulbs are turned on) or an entertainment mode (wherein the light bulbs blink on and off) through the portable device 220, and the selected operating mode and the selected operating time are transmitted to the lamp through the audio signals of the first packet. Next, the lamp can perform the operational program that corresponds to the selected operating mode and the selected operating time, thereby decreasing the setting and controlling time of the lamp and the complexity of the operation for the user. Furthermore, if the home appliance device 210 is an oven or a microwave oven, the user can select the cooking recipes (such as pizza, roast chicken, etc.) through the portable device 220, and the selected operating mode and the selected operating time are transmitted to the oven or the microwave oven through the audio signals of the first packet. Next, the oven or the microwave oven can perform a cooking program according to the selected operating mode and the selected operating time. Moreover, if the home appliance device 210 is a washing machine, the user can select the laundry treatment through the portable device 220, and the selected operating mode and the selected operating time are transmitted to the washing machine through the audio signals of the first packet. Next, the washing machine can perform an operational program according to the selected operating mode and the selected operating time. On the other hand, after the processor 214 obtains the operation setting selected by the user, the processor 214 stores the operation setting in the memory 217. Simultaneously, the processor 214 generates an acknowledgement (ACK) signal. Next, the processor 214 controls the DAC 215 to convert the ACK signal into an audio signal, and transmits the audio signal corresponding to the ACK signal to the portable device 220 through the speaker 216, shown as an arrow 240.

In FIG. 2, in addition to selection of the desired operation setting, the user can also obtain the current operational state, or the previous and/or current operation setting of the home appliance device 210 through the portable device 220. For example, through the input interface 227, the user can require the home appliance device 210 to report back. Thus, in the portable device 220, the processor 223 controls the audio CODEC 222 to convert report-back requirement into audio signals, and transmits the audio signals to the home appliance device 210 through the microphone 226. In the home appliance device 210, in response to the received report-back requirement, the processor 214 will obtain the operational state from the memory 217, wherein the operational state may be the previous operation setting (e.g. the operating mode and the operating time that have been performed), the current operation setting (e.g. the operating mode and the operating time that are being performed), or the current operational state (e.g. the remaining operating mode and the remaining operating time), and so on. Next, the processor 214 controls the DAC 215 to convert the operational state into a second packet having a plurality of audio signals, and to transmit the second packet to the portable device 220 through the speaker 216. Thus, the user can obtain the operational state of the home appliance device 210 through the portable device 220.

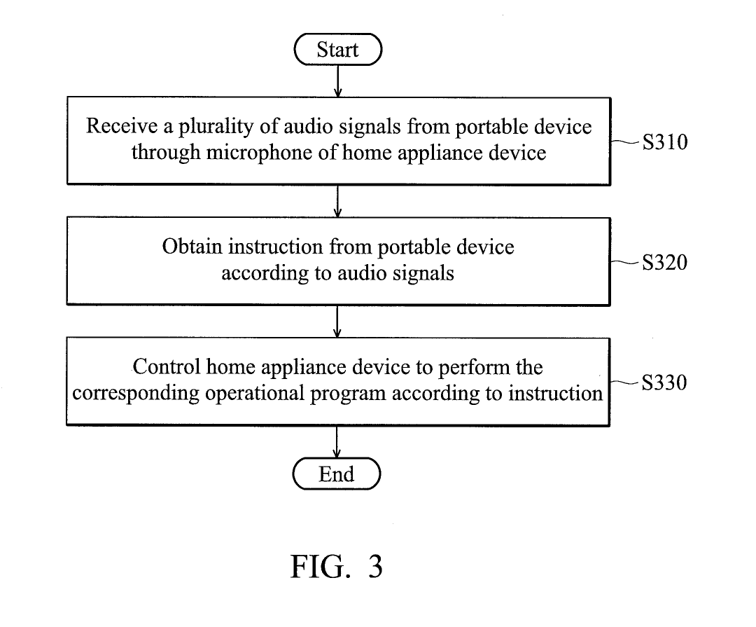

FIG. 3 shows a control method for a home appliance control system according to an embodiment of the present disclosure. Referring to FIG. 2 and FIG. 3 together, first, in step S310, through the microphone 211 of the home appliance device 210, the processor 214 of the home appliance device 210 receives the first packet formed by a plurality of first audio signals from the portable device 220. Next, in step S320, the processor 214 obtains an instruction from the portable device 220 according to all first audio signals of the first packet. As described above, the instruction is capable of providing the operation setting to the home appliance device 210, or reporting back on the operational state of the home appliance device 210. Next, in step S330, the processor 214 controls the home appliance device 210 to perform the corresponding operational program according to the received instruction. As described above, after receiving the instruction, the home appliance device 210 provides the second audio signal corresponding to the ACK signal to the portable device 220 through the speaker 216. Moreover, the home appliance device 210 transmits the second packet formed by a plurality of third audio signals by using the speaker 216, so as to provide the previous and/or current operation setting or operational state to the portable device 220.

While the present disclosure has been described by way of example and in terms of the preferred embodiments, it is to be understood that the present disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A home appliance control system, comprising:
a portable device, comprising:
a first microphone;
a first speaker; and
a first processor configured to provide a first packet formed by a plurality of first audio signals through the first speaker according to an instruction; and
a home appliance device, comprising:
a second microphone configured to receive the first packet from the first speaker of the portable device;
a second speaker; and
a second processor configured to obtain the instruction according to the first audio signals of the first packet received by the second microphone, and control the home appliance device to perform an operational program according to the instruction.

2. The home appliance control system as claimed in claim 1, wherein the first audio signal is a single tone or a multi-tone.

3. The home appliance control system as claimed in claim 1, wherein the first audio signal is an audible sound or ultrasound.

4. The home appliance control system as claimed in claim 1, wherein the instruction comprises an operating mode and an operating time of the home appliance device.

5. The home appliance control system as claimed in claim 1, wherein the home appliance device further comprises:
an analog-to-digital converter configured to convert each of the first audio signals of the first packet into a digital signal;
wherein the second processor obtains the instruction according to the digital signals and generates an acknowledgement signal.

6. The home appliance control system as claimed in claim 5, wherein the home appliance device further comprises:
a digital-to-analog converter configured to convert the acknowledgement signal into a second audio signal;
wherein the portable device receives the second audio signal from the second speaker of the home appliance device through the first microphone, and the first processor of the portable device obtains the acknowledgement signal according to the second audio signal.

7. The home appliance control system as claimed in claim 6, wherein the home appliance device further comprises:
a memory configured to store an operational state of the home appliance device;
wherein the second processor controls the digital-to-analog converter to convert the operational state into a second packet formed by a plurality of third audio signals;
wherein the portable device receives the second packet from the second speaker of the home appliance device through the first microphone, and the first processor of the portable device obtains the operational state of the home appliance device according the third audio signals of the second packet.

8. The home appliance control system as claimed in claim 1, wherein the portable device further comprises:
an input interface configured to receive a user input; and
a wireless communication module configured to obtain an operation setting of the home appliance device from Internet, wherein the operation setting of the home appliance device comprises an operating mode and an operating time of the home appliance device;
wherein the portable device provides the first packet to the home appliance device according to the operation setting and the user input.

9. A control method for a home appliance control system, wherein the home appliance control system comprises a portable device and a home appliance device, comprising:
receiving a first packet formed by a plurality of first audio signals from the portable device through a microphone of the home appliance device;
obtaining an instruction from the portable device according to the first audio signals of the first packet; and
controlling the home appliance device to perform an operational program according to the instruction;
wherein the instruction comprises an operating mode and an operating time of the home appliance device.

10. The control method as claimed in claim 9, wherein the first audio signal is a single tone or a multi-tone.

11. The control method as claimed in claim 9, wherein the first audio signal is an audible sound or ultrasound.

12. The control method as claimed in claim 9, further comprising:
providing a second audio signal corresponding to an acknowledgement signal to the portable device through a speaker of the home appliance device according to the instruction.

13. The control method as claimed in claim 9, further comprising:
providing a second packet corresponding to an operational state of the home appliance device to the portable device through a speaker of the home appliance device according to the instruction, wherein the second packet is formed by a plurality of third audio signals.
